(19) United States
(12) Patent Application Publication
(10) Pub. No.: US 2011/0198446 A1
(43) Pub. Date: Aug. 18, 2011

(54) Device for Eliminating Space Debris in Orbit

(75) Inventors: Ulrich Knirsch, Markdorf (DE); Amrei Temming, Karlsruhe (DE)

(73) Assignee: Astrium GmbH, Taufkirchen (DE)

(21) Appl. No.: 13/028,806

(22) Filed: Feb. 16, 2011

(30) Foreign Application Priority Data
Feb. 17, 2010 (DE) 102010008376.3-22

(51) Int. Cl. B64G 1/52

(52) U.S. Cl. 244/171.7

(57) ABSTRACT

A device for eliminating space debris in orbit, the device including a covering that when struck by an object of space debris breaks this up into multiple pieces of predetermined size, and captures and binds at least many of the pieces. The covering includes at least one layer of deformable fabric that encloses a spatial volume of the device, wherein a foam material is disposed inside the at least one layer for the purpose of retaining shape, the initial volume of the foam material being able to be changed into a final volume that is larger relative to the initial volume, wherein the device has its specified shape and function once the foam material attains its final volume.

### CROSS REFERENCE TO RELATED APPLICATIONS

This application claims priority under 35 U.S.C. §119 to German Patent Application No. 10 2010 008 376.3-22, filed Feb. 17, 2010, the entire disclosure of which is herein expressly incorporated by reference.

### BACKGROUND AND SUMMARY OF THE INVENTION

The invention relates to a device for eliminating space debris in orbit, comprising a covering that when struck by an object of space debris breaks this up into multiple pieces of predetermined size, and captures and binds at least many of the pieces.

The debris created by the continuous and growing exploitation of space endangers satellites and manned space missions. The greatest danger in terms of damage or destruction of satellites or spacecraft here is due here to small objects of space debris that are in the size range of 1 cm or smaller, and in terms of numbers constitute the great majority of space debris objects.

A known means of protecting satellites and/or spacecraft is to mount what is called a Whipple Shield on the exterior of the satellite/spacecraft so as to protect these from the impact of small objects of space debris. The Whipple Shield is generally composed of two metal layers that are separated by an intermediate space. When there is an impact on the first outer layer, which is also called a “bumper,” the object of space debris breaks up into multiple pieces. Upon impact the object of space debris penetrates the first layer. In doing so, the object of space debris fragments and pieces are created. The pieces form a cone. Because the second inner layer is disposed at a certain distance from the first layer and the pieces are formed into a cone shape, the density of the pieces that impact the second layer is reduced. This enables the second layer to capture the pieces completely.

The efficiency of the Whipple Shield is primarily determined by the square of the distance between the first and second layers. As the distance is made greater, however, the usable volume of the payload simultaneously becomes smaller. Due to this relationship, the distance often cannot be sized in such a way that would be required for the Whipple Shield to function effectively. Another disadvantage is that Whipple Shields are relatively heavy and this restricts their use solely to safety-critical space components. Such safety-critical space components include, for example, manned space stations.

Since damage to, or even destruction of, a satellite or spacecraft by objects of space debris can be associated with significant economic losses, the need arises for providing a more effective solution by which the hazard posed by objects of space debris can be reduced.

Exemplary embodiments of the present invention provide a device that employs a simple and inexpensive approach for eliminating space debris in orbit.

The invention provides a device for eliminating space debris in orbit, comprising a covering that upon impact with an object of space debris breaks this up into multiple pieces of a specified size, and captures and binds at least many of these. According to the invention, the covering comprises a layer of deformable fabric that encloses the spatial volume of the device, wherein a foam material is disposed inside the at least one layer to effect retention of shape, the initial volume of the material being able to change into a final volume that is larger relative to the initial volume, wherein the device has its specified shape and function once the foam attains its final volume.

The device according to the invention can be employed autonomously to eliminate objects of space debris that endanger satellites and/or spacecraft. Whenever there is an impact of an object of space debris up to a predetermined size, this object penetrates into the interior of the device—however, in the process it breaks up into multiple pieces. During the impact, these pieces are captured on the inside of the covering. The device according to the invention makes possible the preventive elimination of objects of space debris since there is no need to connect this to a satellite to be protected or to a spacecraft to be protected. As a result, objects of space debris can be captured by a device according to the invention before impact with other components.

Despite a large feasible cross-sectional area, the device according to the invention has a low mass due to the fact that it uses a minimum-mass combination of fabrics both to break up the objects of space debris and to capture the pieces, and to the fact that furthermore the shape is created by a light foam material. In addition, the device according to the invention has a small launch volume due to the fact that the specified shape and function of the device is only provided once it is at the place of use, i.e., in orbit. The result is that objects of space debris can be eliminated a low cost. The use of fabrics for the jacket, and of a foam material to create the spacing between the two layers of the jacket, provides the device with virtually unlimited formability and scalability. This aspect allows the existing extra launch weight of a carrier system to be exploited in ideal fashion (so-called piggyback missions).

Although the device according to the invention is designed primarily to be used autonomously for eliminating objects of space debris, this device can also be employed to protect specific space components along with a simultaneous cleaning effect by mechanically connecting the device to the space component to be protected.

In one specific embodiment, the at least one layer of deformable fabric encloses a core of foam material. The function of this core of foam material is primarily to provide shape, although it also has a certain braking and protective effect. The foam material core can be either of a continuous filling type or hollow.

In particular, the initial volume of the foam material is compressed to around a fraction, in particular, a tenth, of its final volume. Provision is furthermore made whereby the foam material is preferably of an open-pore type so as to achieve low weight and high degree of expansion from the initial volume to the greater final volume.

Alternatively, the foam material can be generated out of multiple components once the device is operating in space. This can be achieved, for example, by precisely mixing substances located within the spatial volume. For example, monomers can be used.

A preferred approach is for the jacket to comprise a first external layer composed of fabric with a high inherent sonic velocity (e.g., Nextel™ fabric from 3M™) so as to achieve fragmentation of an object of space debris. A second inner layer is preferably composed of a tough fabric (e.g., Kevlar™ fabric from DuPont) to capture the fragmentation particles. The two fabrics have the properties referenced above: In response to the impact of an object of space debris up to a predetermined size, the Nextel™ fabric, which is employed as the first, outer layer, breaks this down into multiple pieces. The Kevlar™ fabric, which forms the second, inner layer of the device, captures the segments passing through the covering and the foam material in the interior of the device and binds these. If an object of space debris exceeds the specified size, this object can penetrate completely through the device. Because a foam material is disposed inside the jacket, the device has an inherent stability, thereby allowing the intended protective function to continue to be performed.

In another embodiment, the foam material is compressed by retaining means so as to occupy its initial volume. Cords or netting can be used, by way of example, as the retaining means. The retaining means are advantageously releasable or destructible so as to allow the original volume of the foam material, and optionally of the second foam material, to change into the final volume. In one variant, the retaining means can be disposed inside the spatial volume of the device and then severed after the device has been deployed in space. Alternatively, the retaining means can be disposed on the outside of the covering facing space when the device is in operation. Either cords or netting could be used. After deployment of the device in space, the retaining means are severed from outside the device, thereby enabling the device to assume its specified shape and thus function. The action of the device assuming its specified shape can be produced, for example, by the foam material disposed inside the covering, which material expands, or has been actively induced to expand, once the retaining means have been removed.

In another embodiment, the spatial volume is at least partially filled with material to provide mechanical stability for the jacket. The primary function of the material in the spatial volume is to mechanically stabilize the device, e.g., whenever the jacket has been penetrated by an object of space debris. The material can, for example, be the foam material provided. Optionally, the material can provide self-healing of the jacket when the device is penetrated. The material can be, for example, a self-hardening polymer. This polymer has the particular property of being a hard and thin structure, thereby ensuring form stability in response to damage. Alternatively, the material is composed of at least two mutually miscible monomers that are liquid in their original state, these monomers forming a matrix when mixed and in the process releasing a gas. Here the stability and shape of the device are created from the inside out, i.e., the spatial volume surrounded by the at least one layer. The material ensures that the shape of the device can be maintained even when damaged by a (e.g., excessively large) object of space debris.

It has been found advantageous if the device is rotationally symmetrical relative to at least one axis of rotation once the foam material of the jacket has attained its final volume. It is especially advantageous if the device has a spherical shape since this spatial shape has a large surface area relative to its volume and this enables objects of space debris to be “eliminated” with a high degree of efficiency. Similarly, the device can be of cylindrical shape, which also provides a surface-area-to-volume ratio that is similar to a sphere.

Another advantageous aspect is that the diameter of the device measures at least 50 cm. The diameter of the preferably spherical or cylindrical device measures approximately 1 m. This, first of all, allows a sufficiently large distance to be created between the first and second impact on the covering, thereby ensuring the device has a high capture efficiency. Secondly, the device then is of a size that can be easily transported into space in the compressed state, and is of sufficient size in the final state for capturing objects of space debris. In this regard, what has been found sufficient is for the wall thickness of the foam material core to measure approximately 10 cm

Other objects, advantages and novel features of the present invention will become apparent from the following detailed description of one or more preferred embodiments when considered in conjunction with the accompanying drawings.

### BRIEF DESCRIPTION OF THE DRAWINGS

The following discussion describes the invention in more detail based on the figures. Here:

FIG. 1 illustrates a first embodiment of a device according to the invention for eliminating space debris in orbit, and

FIG. 2 illustrates a second embodiment of a device according to the invention for eliminating space debris in orbit.

### DETAILED DESCRIPTION OF THE DRAWINGS

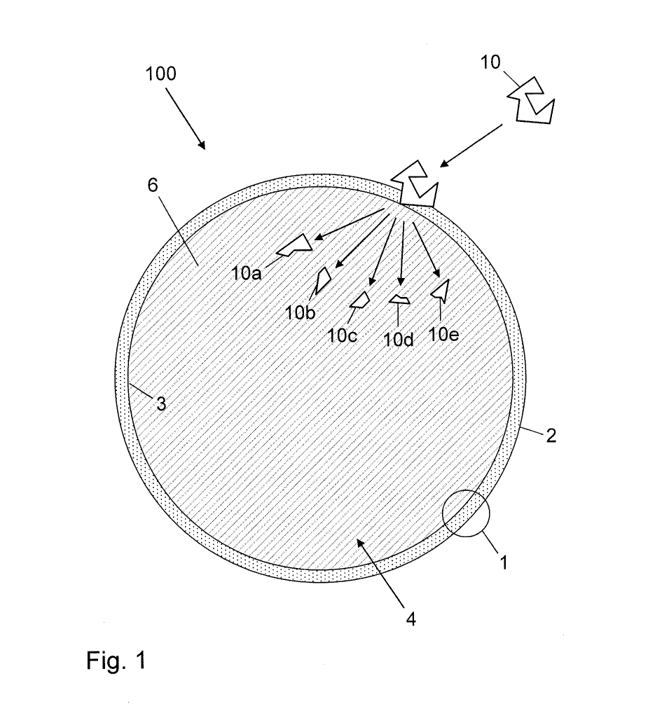

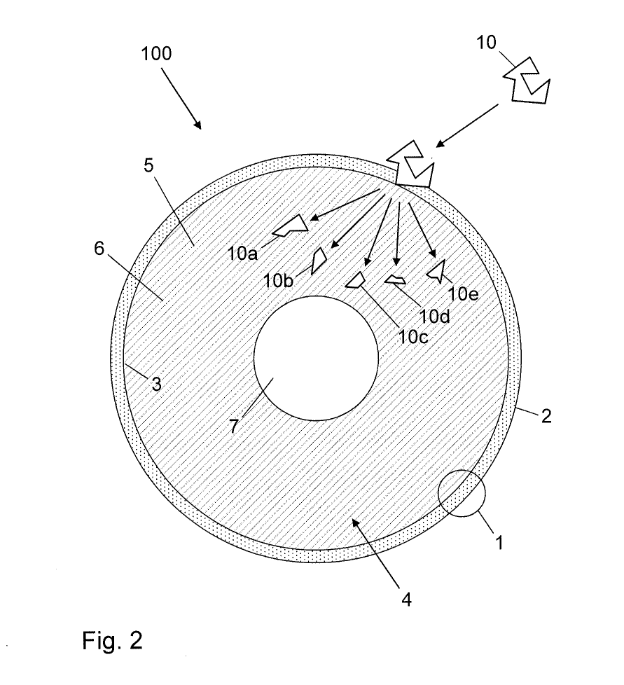

FIGS. 1 and 2 illustrate embodiments of a device 100 according to the invention for eliminating space debris in orbit. In particular, objects of space debris in the sub-centimeter range, in particular, can be captured and bound by the device 1 according to the invention.

Each of devices 100 comprises a covering 1 including a first, outer layer 2 composed of a woven ceramics fabric such as a Nextel™ fabric, and a second inner layer 3 composed of a para-aramid synthetic fiber such as a Kevlar™ fabric. Covering 1 can be designed as a double layer. The material properties of the first and second layers 2, 3 composed of fabric are selected such that, in response to an impact of an object of space debris 10, this object of space debris 10 breaks up into multiple pieces 10a, . . . , 10e. Second inner layer 3 captures pieces 10a, . . . , 10e of object of space debris 10 to the greatest extent possible inside jacket 1 and binds the debris.

First and second layers 2, 3 form jacket 1 of device 100, this jacket enclosing a spatial volume 4 of device 100. A foam material 6, such as an open-pore foam material, is disposed in the covering or jacket 1. Spatial volume 4 can be at least partially filled with foam material 6, the function of which is described in more detail below. FIGS. 1 and 2 illustrate a device 100 in a state in which foam material 6 has its final volume, thereby providing device 100 with its specified shape, which in the illustrated embodiment is a spherical shape. Since the protective function of jacket 1 depends on the spacing between the first and second impacts, in principle the diameter must be designed to be as large as possible. A diameter measuring at least around 50 cm is considered appropriate for capturing and binding objects of space debris in the sub-centimeter range.

Based on the materials selected for jacket 1, device 100 according to the invention can be easily reduced in size, thereby enabling the device to be easily and inexpensively transported into space. Foam material, in particular, an open-pore foam material can easily be compressed to a tenth of its final volume. The foam material can be produced in virtually any form, the material in this invention being covered by layers of fabric 2, 3, respectively composed of, for example, a woven ceramics fabric (e.g., a Nextel™ fabric) a para-aramid synthetic fiber fabric (e.g., a Kevlar™ fabric). The main function of the foam material is to reliably maintain the shape of the device even after undergoing an impact by space debris. Due to its low weight and its technical properties, the material contributes to capturing and binding pieces of the object of space debris shattered by the first layer.

Since the direction of the impact by an object of space debris striking device 100 cannot be predicted, device 100 is of symmetrical design, at least relative to one axis. Spherical or cylinder designs are particularly suitable.

Geometrical analyses can demonstrate that the ratio between surface area and mass becomes larger as the diameter of the device becomes smaller. This ratio represents an indicator of the efficiency of device 100. Specifically, On the other hand, small diameters reduce the spacing between the layers of the first jacket 1, and thus diminish the protective effect. Since device 100 according to the invention is passive, i.e., it does not possess an independent propulsion means, device 100 itself presents a certain collision risk for spacecraft and/or satellites in orbit. Since with increasingly reduced diameters device 100 could also become more difficult for satellites and/or spacecraft to detect, the proposed diameter for device 100 of spherical or cylindrical shape is 50 cm up to 1 m. This achieves a good compromise between detectability and hazard potential.

If device 100 is provided in the form of a cylinder, this preferably has a maximum length of 4 m and a diameter of 1 m. The ratio of cross-sectional area to volume (A/V) and the ratio of cross-sectional area to mass (A/m) with a cylindrical device are almost identical to corresponding values for a spherical device. The spherical device has the advantage, however, of having a larger cross-sectional area for objects of space debris being captured that are on eccentric orbits. This produces an improved “cleaning effect” as compared with cylindrical devices. Spherical devices furthermore have the advantage whereby it is simpler to transport a number of compressed spheres into orbit as secondary payload. Conversely, a cylindrical device would retain its length even when the device is compressed radially. For this reason, it is more difficult to carry a cylindrical device as additional payload.

Mechanical retaining means can be provided for transporting the device, these retaining means compressing foam material 6 so as to occupy its initial volume. For example, radially applied cords or ropes can be provided inside device 100, i.e., in spatial volume 4, which are then severed after device 100 has been deployed in space, thereby allowing the foam material to assume its final volume. Alternatively, cords or ropes can be wrapped around the outside of the jacket, which could then be severed after deployment in space. Similarly conceivable are a netting or covering of foil/film that contains a plurality of devices 100 in compressed form, the netting being opened or severed when devices 100 are deployed.

In principle, provision only of jacket 1 is required to provide the protective effect for device 100. For this reason, it is sufficient if the structure, i.e., the shape of the device is not created until it is in orbit—regardless of the shape that device 100 is actually intended to have. Provision can be made whereby the interior (spatial volume 4) is filled continuously with the foam material (FIG. 1), or a self-healing component is provided in device 100, so as to maintain the shape of device 100 even after the jacket has been penetrated and/or damaged by incoming objects of space debris. The spatial volume of device 100 can, for example, be filled with a self-hardening material, such as a foam material.

In the embodiment of FIG. 1, foam material 6 fills out spatial volume 4 completely, while in the embodiment of FIG. 2 only a portion of spatial volume 4 is filled and thus a foam material core 5 is provided. A region 7 left free of foam material 6 is located at the center of spherical device 100.

Foam material 6 can be composed of two mutually miscible monomers that are preferably liquid when in their original state. A matrix is created when two monomers are mixed. In addition, a gas is generated that enables the matrix to transition into foam material. It is possible here to use a small proportional volume of liquid component to produce a hundred times the volume of foam material. Monomers are known that can provide the described functionality at the temperatures found in space.

Device 100 according to the invention uses a combination of fabrics of minimal mass to eliminate objects of space debris, both in terms of breaking up the objects of space debris and capturing the disintegrated pieces. The spacing between the first and second impacts on the covering is provided by a foam material composed of a plastic. This enables the distance between the first and second layers to be enlarged as compared with conventional devices, thereby easily multiplying the capture efficiency since it is possible to use compression to facilitate transport.

The foam material itself further enhances the capture efficiency, while simultaneously counteracting the build-up of pieces. Objects of space debris that exceed the design-specified size are nevertheless shattered by device 100, where the shattered pieces emerge at diminished velocity. These then pose a reduced hazard potential.

Device 100 according to the invention can be used preventatively and autonomously, i.e., independently of a satellite or a spacecraft.

Devices according to the invention can be transported into space easily and inexpensively due to the materials used. In particular, these possess a high capture efficiency along with low mass, low initial volume, and low cost.

In one embodiment, the invention can alternatively also be installed on a satellite requiring protection or other spacecraft (e.g., manned spacecraft). These are then protected in a manner that is efficient in terms of mass and space required. At the same time, a certain cleaning function is a positive side effect.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for eliminating space debris in orbit, comprising:
a covering that when struck by an object of space debris breaks the space debris into multiple pieces of predetermined size, and captures and binds at least many of the pieces, wherein the covering comprises at least one layer of deformable fabric that encloses a spatial volume of the device;
a foam material disposed inside the at least one layer, the foam material retaining a shape of the device, wherein an initial volume of the foam material is changeable into a final volume that is larger relative to the initial volume, wherein the device has its specified shape and function once the foam material attains its final volume.

2. The device according to claim 1, wherein the at least one layer of deformable fabric encloses a foam material core.

3. The device according to claim 1, wherein the foam material in its original volume is compressed to approximately a tenth of its final volume.

4. The device according to claim 1, wherein the foam material is an open-pore type foam material.

5. The device according to claim 1, wherein the foam material is generated out of multiple components when the device is operating in space.

6. The device according to claim 1, wherein the covering comprises a first outer layer composed of a fabric of high inherent sonic velocity.

7. The device according to claim 6, wherein the covering comprises a second inner layer composed of a tough fabric.

8. The device according to claim 1, wherein the foam material is compressed by retaining means to occupy its initial volume.

9. The device according to claim 8, wherein the retaining means are disposed inside the spatial volume of the device.

10. The device according to claim 8, wherein the retaining means are disposed on the outside of the covering facing space when the device is in operation.

11. The device according to claim 8, wherein the retaining means are releasable or destructible so as to allow the original volume of the foam material to change into the final volume.

12. The device according to claim 1, wherein the spatial volume is at least partially filled with the foam material to provide mechanical stabilization of the covering.

13. The device according to claim 12, wherein the foam material comprises a self-hardening polymer.

14. The device according to claim 12, wherein the foam material is composed of at least two mutually miscible monomers that are liquid in their original state, the monomers forming a matrix when mixed and at the same time releasing a gas.

15. The device according to claim 1, wherein device is rotationally symmetrical relative to at least one axis of rotation when the foam material is at its final volume.

16. The device according to claim 1, wherein a diameter of the device measures at least 50 cm.

17. The device according to claim 1, wherein the foam material surrounds a region free of foam material and the foam material has a wall thickness of between 5 and 15 cm.

18. The device according to claim 17, wherein the wall thickness of the foam material is 10 cm.
